(19) United States
(12) Patent Application Publication
(10) Pub. No.: US 2018/0043360 A1
(43) Pub. Date: Feb. 15, 2018

(54) SEALING DEVICE OF MICROFLUIDIC CHIP AND OPERATION METHOD THEREFOR

(71) Applicant: NANOBIOSYS INC., Seoul (KR)

(72) Inventors: Sung Woo KIM, Seoul (KR); Jae Young BYUN, Anyang-si (KR); Jung Hwan LEE, Anyang-si (KR); Duck Joong KIM, Anyang-si (KR); Jun HUR, Suwon-si (KR); Eun Sub KIM, Bucheon-si (KR); Song Gyun JUNG, Gwangmyeong-si (KR)

(21) Appl. No.: 15/526,956

(22) PCT Filed: Oct. 27, 2015
(86) PCT No.: PCT/KR2015/011371

§ 371 Date: Jul. 31, 2017

(30) Foreign Application Priority Data
Nov. 14, 2014 (KR) 10-2014-0158794

(51) Int. Cl. B01L 3/00; B01L 9/00

(52) U.S. Cl. CPC B01L 3/502715; B01L 9/527; B01L 2200/142; B01L 2200/0689; B01L 2300/0816; B01L 2300/18; B01L 2200/147

(57) ABSTRACT

According to one embodiment of the present invention, a sealing device of a microfluidic chip and an operation method therefor are provided. The device can comprise: a support part in which the microfluidic chip is arranged; and a heat sealing part applying heat to an inlet part and an outlet part of the microfluidic chip so as to seal the inlet part and the outlet part.

### TECHNICAL FIELD

The present invention relates to a sealing device of a microfluidic chip and an operation method therefor, and specifically, to a sealing device of a microfluidic chip and an operation method therefor, which seals the microfluidic chip by applying heat to the microfluidic chip.

The present invention has been derived from a study developed under the support of a health care Research and Development project sponsored by the Korea Health Industry Development Institute (Project No: HI13C2262, Project name: Development of fully automated real-time PCR system capable of simultaneously detecting multiple channels on the basis of lap-chip, the PCR system for high-speed diagnosis of genes for onsite malaria inspection).

### BACKGROUND ART

A microfluidic chip has a function of flowing fluid through a microfluidic channel and simultaneously conducting several experiment conditions. Specifically, the microfluidic channel is manufactured using a substrate of plastic, glass, silicon or the like (or a material of a chip), and after moving the fluid (e.g., a liquid sample) through the channel, the fluid may be, for example, mixed and reacts in a plurality of chambers in the microfluidic chip. Thus, the microfluidic chip is also referred to as a lab-on-a-chip in that experiments conventionally performed in a laboratory are performed in a small chip.

The microfluidic chip has the ability to lower costs and save time in the fields of pharmacy, biological engineering, medical science, chemistry and the like, and may also enhance accuracy, efficiency, and reliability. For example, since the amounts of expensive reagents used for culture, proliferation and differentiation of cells can be remarkably reduced compared with existing methods by using the microfluidic chip, cost can be reduced considerably. In addition, since much smaller amounts of protein samples and cell samples are used in comparison to existing methods. Also, image analysis can be made using the microfluidic chip, therefore the amounts of the used or consumed samples and analysis time of the samples can be reduced.

However, a problem occurs when the fluid is evaporated and lost due to the heat applied to a reaction region while a certain reaction,particularly, a polymerase chain reaction (PCR), is performed in the microfluidic chip, or the fluid is leaked from the microfluidic chip where the reaction is taking place. A sealing technique has been proposed to solve the problem wherein a valve or a sealing cap for sealing the reaction region in the microfluidic chip is used at both ends, customarily at an inlet unit and an outlet unit, of the reaction region.

However, a problem with such sealing technique is that a multitude of bubbles are generated due to the evaporation of the fluid in the reaction region. In relation to this, FIG. 1 shows a PCR reaction result of a conventional PCR chip. As shown in the figure, while the reaction is progressed, the fluid is evaporated and a multitude of bubbles is generated due to the heat applied to the fluid (see FIG. 1(a)). Since the bubbles make it difficult to precisely measure the inside of the reaction region, and results of the reaction are, therefore distorted due to the bubbles, there is a problem in regards to degrading the reliability (see FIG. 1(b)).

Therefore, a sealing device of a microfluidic chip and an operation method therefor are required to solve such problems.

### DISCLOSURE OF INVENTION

### Technical Problem

The present invention has been devised to solve the problems described above. An objective of the present invention is to provide a sealing device of a microfluidic chip and an operation method therefor, wherein the seal of the microfluidic chip by applying heat through the sealing device of a microfluidic chip.

### Technical Solution

According to an embodiment of the present invention, a sealing device of a microfluidic chip is provided. The sealing device may include: a support unit on which the microfluidic chip is arranged; and a heat-sealing unit for sealing an inlet unit and an outlet unit of the microfluidic chip by applying heat to the inlet unit and the outlet unit.

Preferably, the heat-sealing unit may seal the inlet unit and the outlet unit by melting protrusion units of the inlet unit and the outlet unit by contacting and heating the inlet unit and the outlet unit.

In addition, preferably, the heat-sealing unit may include: heat contact units thermally contacting with the inlet unit and the outlet unit of the microfluidic chip; heaters for heating the heat contact units; and a temperature sensor for measuring temperature of the heat contact units.

In addition, preferably, a chip contact region of the heat contact unit may be formed to be recessed toward the inside so that the protrusion units melted by the heat contact units may seal openings of the inlet unit and the outlet unit.

In addition, preferably, a release agent may be coated on the surface of the chip contact regions of the heat contact units.

In addition, preferably, the sealing device may further include a driving unit for moving the heat-sealing unit toward the microfluidic chip arranged on the support unit to apply heat to the inlet unit and the outlet unit of the microfluidic chip through the heat-sealing unit.

In addition, preferably, the heat-sealing unit may further include a chip fixing unit for preventing shake of the microfluidic chip when the heat-sealing unit is moved and thermally contacted by the driving unit.

In addition, preferably, the chip fixing unit may be protruded toward the support unit, and a protrusion length of the chip fixing unit may be adjusted by implementing at least a portion of the chip fixing unit using an elastic material.

In addition, preferably, the support unit may be recessed toward the inside to form an arrangement space of the microfluidic chip.

According to an embodiment of the present invention, a sealing system of a microfluidic chip is provided. The system may include a microfluidic chip and a sealing device of a microfluidic chip.

According to an embodiment of the present invention, an operation method of a sealing device of a microfluidic chip is provided. The method may include the steps of: providing the microfluidic chip on a support unit of the sealing device; heating a heat-sealing unit of the sealing device; moving the heated heat-sealing unit onto the microfluidic chip to melt at least a portion of an inlet unit and an outlet unit by contacting and heating the inlet unit and the outlet unit of the microfluidic chip; and sealing the microfluidic chip by hardening at least a portion of the melted inlet and outlet units.

According to an embodiment of the present invention, a microfluidic chip is provided. The microfluidic chip may include: an inlet unit through which a fluid flows in; a reaction region in which a certain reaction is performed on the fluid flowed in through the inlet unit; and an outlet through which the fluid flows out from the reaction region, wherein each of the inlet unit and the outlet unit includes an opening through which the fluid flows in and a protrusion unit which is defined to be protruded and located adjacent to the opening.

Preferably, the protrusion unit may seal the opening as it is applied with heat and melted.

In addition, preferably, the reaction may be a polymerase chain reaction (PCR).

### Advantageous Effects

According to the present invention, a microfluidic chip can be sealed by applying heat to an inlet unit and an outlet unit of the microfluidic chip using a sealing device of a microfluidic chip, since at least a part of the inlet unit and the outlet unit is melted and hardened by the heat.

In addition, according to the present invention, since each of the inlet unit and the outlet unit of the microfluidic chip includes an opening through which a fluid flows in and a protrusion unit which is protruded and located adjacent to the opening, when a sealing operation is performed by the sealing device of the microfluidic chip, the inlet unit and the outlet unit of the microfluidic chip can be sealed further easily.

Therefore, loss of the fluid injected inside the microfluidic chip can be prevented, and at the same time, accuracy and promptness of reaction results can be improved by eliminating generation of bubbles although a certain reaction is performed on the microfluidic chip.

### BRIEF DESCRIPTION OF THE DRAWINGS

To sufficiently understand the figures cited in the detailed description of the present invention, brief description of each figure is provided.

FIG. 1 shows a PCR reaction result of a conventional PCR chip.

FIG. 2 shows a microfluidic chip according to an embodiment of the present invention.

FIG. 3 shows a sealing device of a microfluidic chip according to an embodiment of the present invention.

FIG. 4 shows a heat-sealing unit according to an embodiment of the present invention.

FIG. 5 shows a heat-sealing unit according to an embodiment of the present invention.

FIG. 6 shows a heat-sealing unit according to an embodiment of the present invention.

FIG. 7 shows a heat-sealing unit according to an embodiment of the present invention.

FIG. 8 shows an operation method of a sealing device of a microfluidic chip according to an embodiment of the present invention.

FIGS. 9 to 11 show a sealing process of a sealing system of a microfluidic chip according to an embodiment of the present invention.

FIG. 12 shows an exemplary sealing result of a microfluidic chip according to an embodiment of the present invention.

FIG. 13 shows an exemplary reaction result of a sealed microfluidic chip according to an embodiment of the present invention.

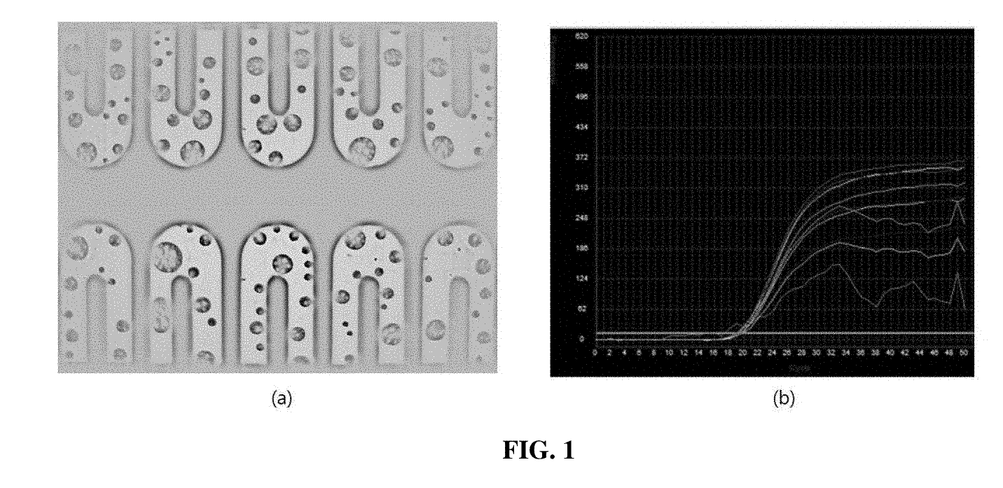

### BEST MODE FOR CARRYING OUT THE INVENTION

Hereinafter, embodiments according to the present invention will be described with reference to the accompanying drawings. It should be noted that in assigning reference numerals to constitutional components of each figure, although the identical components are shown in different figures, they have an identical reference numeral if possible. Further, in describing the embodiments of the present invention, specific descriptions of related well-known configurations or functions are determined to hinder understanding of the embodiments of the present invention, detailed description thereof will be omitted. In addition, although the embodiments of the present invention will be described hereinafter, the spirits of the present invention will not be limited or restricted by the embodiments and will be modified and diversely embodied by those skilled in the art.

Throughout the specification, when an element is referred to as being “connected to” another element, this includes a case of “indirect connection” with intervention of another element therebetween, as well as a case of “direct connection”. Throughout the specification, when an element is referred to as “including” a certain constitutional component, it means that the element does not exclude the component, but further includes the component unless otherwise specifically mentioned. In addition, in describing a constitutional component of an embodiment of the present invention, terms such as a first, a second, A, B, (a), (b) and the like may be used. These terms are used only to distinguish one component from the others, and the nature, the sequence, the order or the like of a corresponding component is not restricted by the terms.

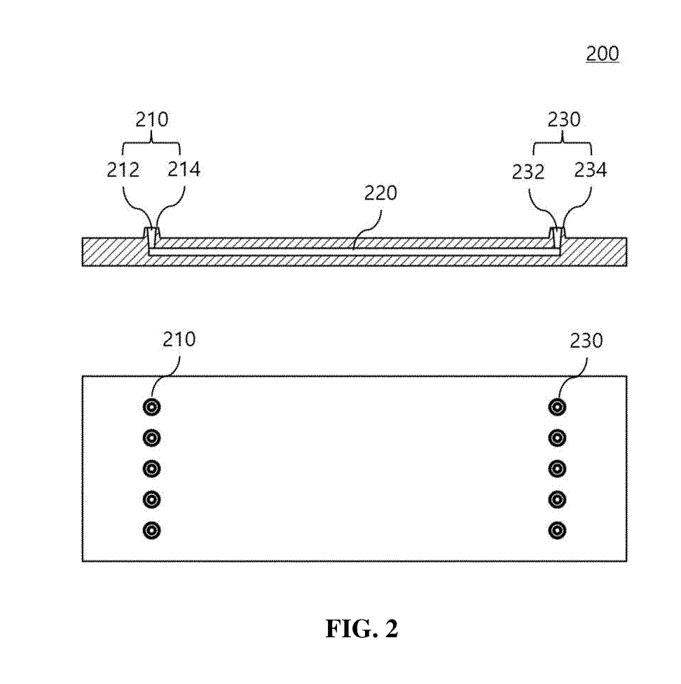

FIG. 2 shows a microfluidic chip according to an embodiment of the present invention.

A microfluidic chip 200 is a chip operating together with a sealing device 300 of the microfluidic chip to perform sealing and may include an inlet unit 210, a reaction region 220, and an outlet unit 230 as shown in the figure.

In the microfluidic chip 200, the fluid flowing through the inlet unit 210 performs a predetermined reaction in the reaction region 220 and may flow out through the outlet unit 230 thereafter. Here, although the reaction may be a PCR reaction, this is only an example, and various reactions may be performed according to embodiments to which the present invention is applied.

Each of the inlet unit 210 and the outlet unit 230 may include an opening 212 and 232 through which a fluid flows in and a protrusion unit 214 and 234 which is defined to be protruded and locatedadjacent to the opening 212 and 232. As is described below in further detail, since heat is applied to the protrusion units 214 and 234 by the sealing device 300 of the microfluidic chip (particularly, heat contact units 322 of the sealing device 300 of the microfluidic chip), at least a part of the protrusion units 214 and 234 is melted, and at least a part of the melted protrusion units 214 and 234 moves to the openings 212 and 232 and hardened to seal the openings 212 and 232.

Through the sealing accomplished like this, loss of the fluid injected inside the microfluidic chip 200, which occurs in the reaction region 220 or before and after the reaction region 220, and degradation of reliability of reaction results caused by generation of bubbles can be prevented. For example, if a PCR reaction is performed in the reaction region 220, reliable CT and fluorescent signal values of the PCR can be obtained by preventing generation of bubbles, and it is not limited thereto.

The configuration or the structure of the microfluidic chip 200 shown in FIG. 2 is only an example, and microfluidic chips 200 of various configurations or structures may be used according to embodiments to which the present invention is applied. In addition, the microfluidic chip 200 shown in FIG. 2 may be utilized as various chips which require sealing, such as a biochip, a diagnosis chip, a microchip and the like.

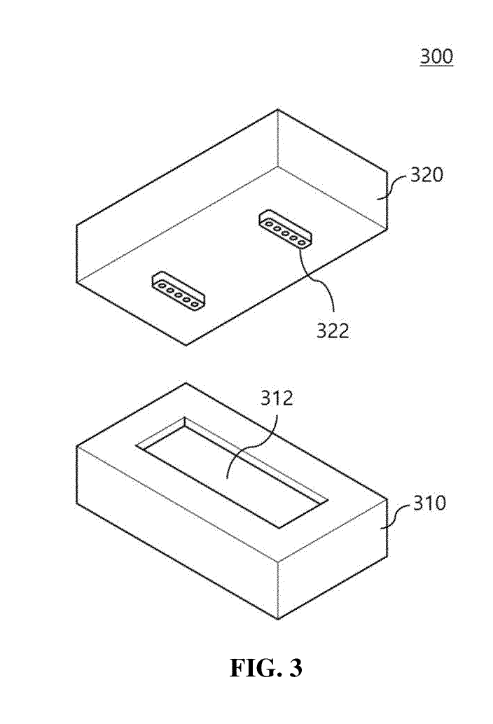

FIG. 3 shows a sealing device of a microfluidic chip according to an embodiment of the present invention.

As shown in the figure, the sealing device 300 of the microfluidic chip may include a support unit 310 and a heat-sealing unit 320.

The microfluidic chip 200 may be arranged on the support unit 310. Since the surface of the support unit 310 is formed to be recessed toward the inside to this end, an arrangement space 312 of the microfluidic chip 200 may be provided. Although the space 312 preferably has a size corresponding to the size of the microfluidic chip 200, it may have a variety of sizes according to embodiments. In addition, although it is shown in FIG. 3 that the arrangement space 312 is provided as the surface of the support unit 310 is recessed, this is only an example, and various means for arranging and/or fixing the microfluidic chip 200 may be used according to embodiments to which the present invention is applied.

The heat-sealing unit 320 may seal the inlet unit 210 and the outlet unit 230 by applying heat to the microfluidic chip 200 arranged on the support unit 310. More specifically, the heat-sealing unit 320 may include heat contact units 322 thermally contacting with the inlet unit 210 and the outlet unit 230 of the microfluidic chip 200, and the protrusion units 214 and 234 of the inlet unit 210 and the outlet unit 230 may be melted by contacting and heating the inlet unit 210 and the outlet unit 230 of the microfluidic chip 200 through the heat contact units 322. As the melted protrusion units 214 and 234 move to the openings 212 and 232 and are hardened thereafter, the openings 212 and 232 of the inlet unit 210 and the outlet unit 230 may be sealed. The hardening may be accomplished by blocking the heat applied to the microfluidic chip 200 as the heat-sealing unit 320 contacting with the microfluidic chip 200 is separated from the microfluidic chip 200 or the heat contact units 322 of the heat-sealing unit 320 is cooled down.

Although it is not shown in the figure, the sealing device 300 of the microfluidic chip may further include a driving unit according to embodiments. The driving unit may move the heat-sealing unit 320 toward the support unit 310. More specifically, the driving unit may move the heat-sealing unit 320 toward the support unit 310 (or the microfluidic chip 200 on the support unit 310) to apply heat to the microfluidic chip 200 or separate the heat-sealing unit 320 from the support unit 310 (the microfluidic chip 200 on the support unit 310).

The configuration or the structure of the sealing device 300 of the microfluidic chip shown in FIG. 3 is only an example, and sealing devices of a microfluidic chip of various configurations or structures may be used according to embodiments to which the present invention is applied.

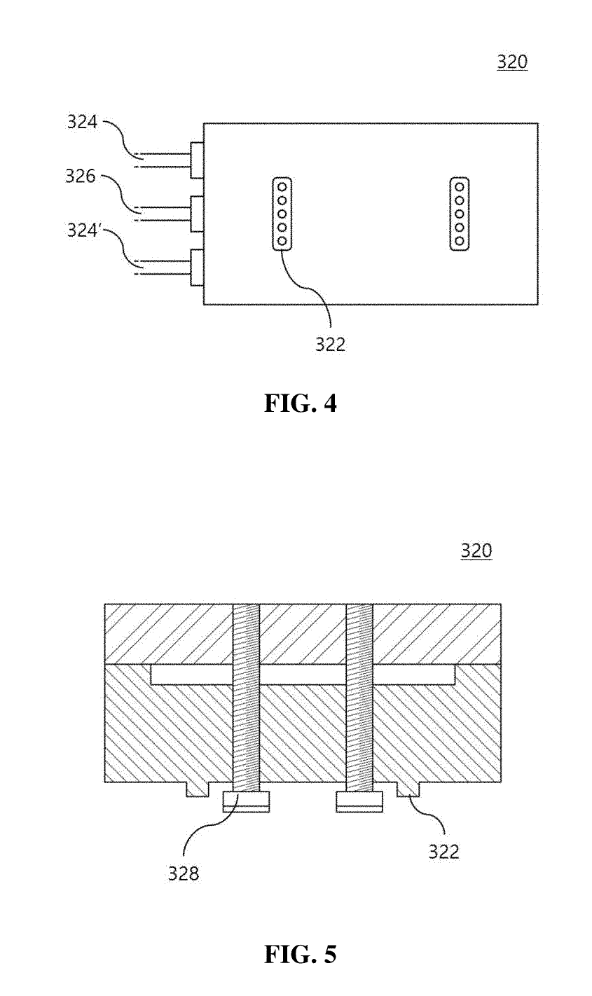

FIG. 4 shows a heat-sealing unit according to an embodiment of the present invention.

As shown in the figure, the heat-sealing unit 320 may further include heaters 324 and 324′ for heating the heat contact units 322 and a temperature sensor 326 for measuring temperature of the heat contact units 322.

That is, the heaters 324 and 324′ may heat the heat contact units 322, and the heating may be performed until a predetermined temperature is measured by the temperature sensor 326. Here, the temperature may be a temperature suitable for melting the protrusion units of the inlet unit 210 and the outlet unit 230 of the microfluidic chip 200. After the heaters 324 and 324′ heat the heat contact units 322 to a predetermined temperature, the heated heat contact units 322 apply heat to the inlet unit 210 and the outlet unit 230 of the microfluidic chip 200 by contacting with the inlet unit 210 and the outlet unit 230, and at least a portion of the inlet unit 210 and the outlet unit 230 may be melted down.

The configuration of the heat-sealing unit 320 shown in FIG. 4 is only an example, and various configurations may be applied according to embodiments to which the present invention is applied.

FIG. 5 shows a heat-sealing unit according to an embodiment of the present invention.

As shown in the figure, the heat-sealing unit 320 may further include a chip fixing unit 328.

The chip fixing unit 328 may be formed to be protruded from the heat-sealing unit 320 toward the support unit 310, and the protruded chip fixing unit 328 may fix the microfluidic chip 200 to the support unit 310 by applying force to the microfluidic chip 200 arranged on the support unit 310 in a predetermined direction (e.g., in a lower direction). According to the chip fixing unit 328 like this, unstable movement of the microfluidic chip 200 can be prevented when the heat-sealing unit 320 moves and thermally contacts by the driving unit.

The chip fixing unit 328 is preferably formed to be protruded as much as to prevent shake of the microfluidic chip 200 without damaging the microfluidic chip 200, and according to embodiments, the protrusion length of the chip fixing unit 328 can be adjusted by implementing at least a portion of the chip fixing unit 328 using an elastic material. For example, since the protrusion length of the chip fixing unit 328 is shortened as the elastic material contracts when a force larger than a predetermined threshold value is applied to the chip fixing unit 328, damage of the protruded part to the microfluidic chip 200 can be prevented, and at the same time, the microfluidic chip 200 can be fixed.

More specifically, according to the configuration as described above, as the heat-sealing unit 320 moves to the support unit 310, the protruded chip fixing unit 328 may eliminate shake of the microfluidic chip 200 by applying force to the microfluidic chip 200 in a predetermined direction as soon as contacting with the microfluidic chip 200 arranged on the support unit 200. Subsequently, if a movement of the heat-sealing unit 320 continues in the lower direction, at least a portion of the chip fixing unit 328 implemented using an elastic material moves or contracts toward the inside of the heat-sealing unit 320, and thus the protrusion length of the chip fixing unit 328 can be adjusted. Accordingly, the unstable movement of the microfluidic chip 200 can be effectively eliminated by continuously applying force to the microfluidic chip 200 without damaging the microfluidic chip 200. In addition, according to the configuration as described above, since the chip fixing unit 328 does not need to be replaced or changed even when the dimension of the microfluidic chip 200 changes, reduction of cost and convenience of using the device can be provided.

The chip fixing unit 328 shown in FIG. 5 is only an example, and various configurations of the chip fixing unit may be applied according to embodiments to which the present invention is applied.

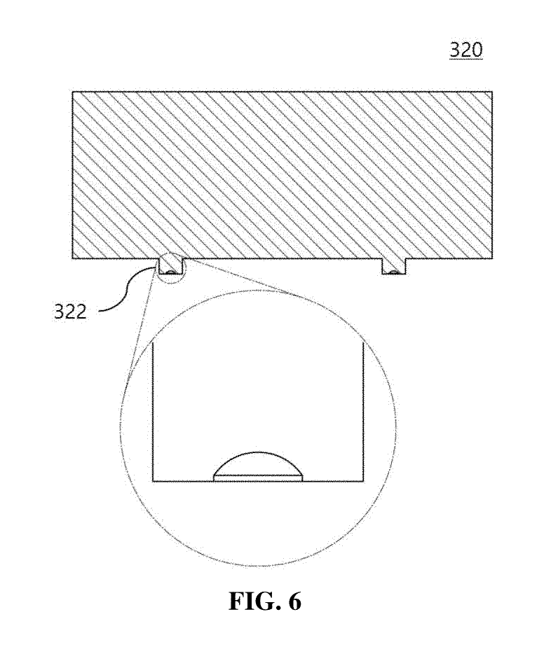

FIG. 6 shows a heat-sealing unit according to an embodiment of the present invention.

As shown in the figure, the heat contact units 322 of the heat-sealing unit 320 may be formed to be recessed toward the inside. As is described below in further detail, according to the configuration of the heat contact units 322 formed to be recessed toward the inside, the protrusion units 214 and 234 of the microfluidic chip 200 melted by the heat contact units 322 may easily move to the openings 212 and 232 of the inlet unit 210 and the outlet unit 230.

Although it is not shown in FIG. 6, according to embodiments, a release agent may be coated on the surface of the heat contact units 322 thermally contacting with the microfluidic chip 200. Here, the release agent is for preventing an attachment of unnecessary materials to the heat contact units 322 by easily releasing the melted protrusion units 214 and 234 from the heat contact units 322, and although silicon resin, paraffin, wax or the like can be used, it is not limited thereto.

The configuration or the structure of the heat contact units 322 shown in FIG. 6 is only an example, and heat contact units of various configurations or structures may be used according to embodiments to which the present invention is applied.

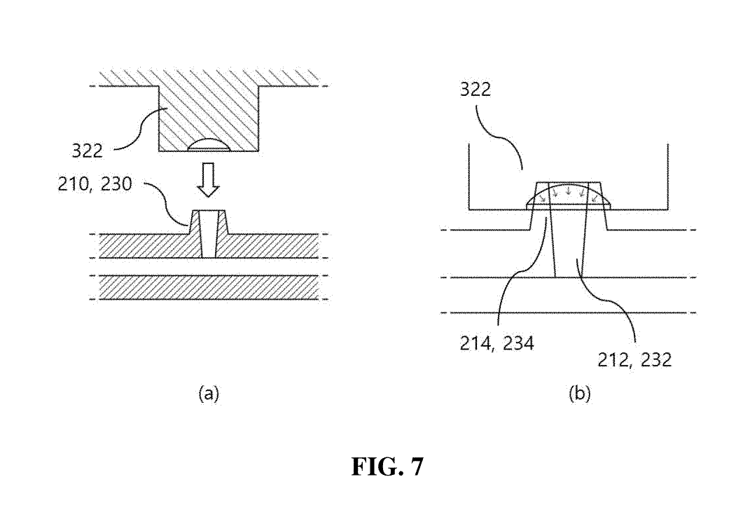

FIG. 7 shows a heat-sealing unit according to an embodiment of the present invention.

If the heat-sealing unit 320 moves toward the support unit 310 (see FIG. 7(a), the heat contact units 322 of the heat-sealing unit 320 may move at least a portion of the protrusion units 214 and 234 of the microfluidic chip 200 melted by the heat contact units 322 not to unnecessary directions (e.g., the outsides of the openings 212 and 232), but toward the openings 212 and 232 (particularly, toward the insides of the openings 212 and 232) (see FIG. 7(b)). The at least a portion of the melted protrusion units 214 and 234 moved to the openings 212 and 232 is hardened thereafter and seal the openings 212 and 232.

That is, according to the configuration of the heat contact unit 322 formed to be recessed toward the inside, since at least a portion of the protrusion units 214 and 234 melted by the heat contact units 322 may easily move to the openings 212 and 232, further precise and effective sealing can be accomplished.

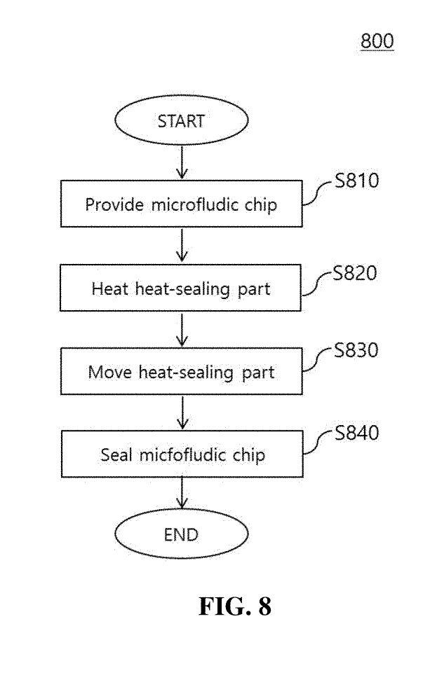

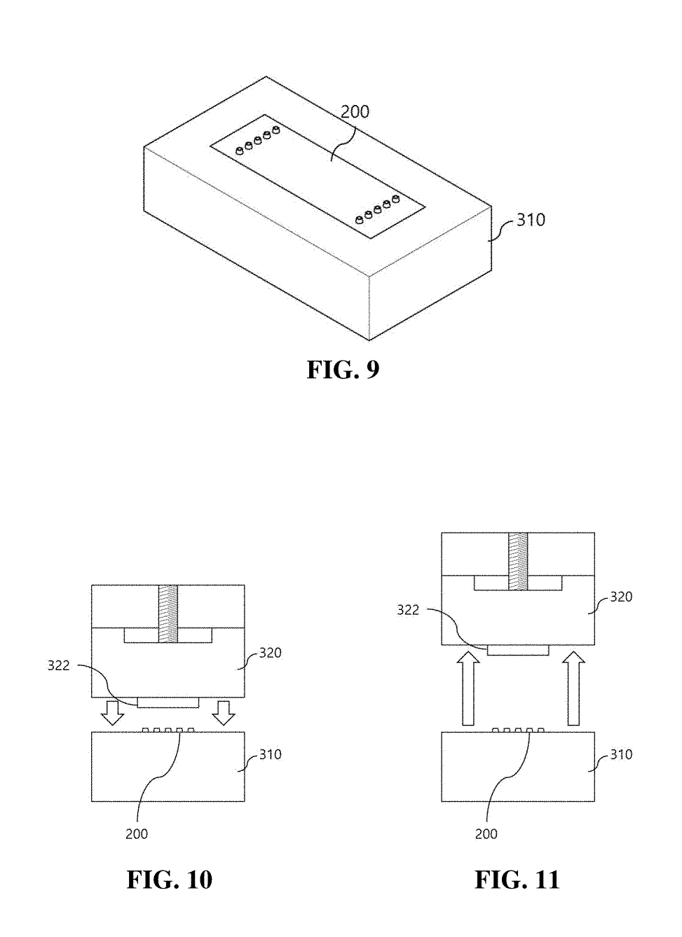

FIG. 8 shows an operation method of a sealing device of a microfluidic chip according to an embodiment of the present invention, and FIGS. 9 to 11 show a sealing process of a sealing system of a microfluidic chip according to an embodiment of the present invention. Here, the system may include a microfluidic chip and a sealing device of the microfluidic chip.

First, referring to FIG. 8, a microfluidic chip 200 may be provided in the sealing device 300 of the microfluidic chip (step S810). More specifically, step S810 may be accomplished by arranging the microfluidic chip 200 on the support unit 310 of the sealing device 300 (particularly, in the arrangement space 312 of the microfluidic chip 200 formed in the support unit 310) (see FIG. 9). According to embodiments, a step of further firmly fixing the microfluidic chip 200 to the support unit 310 may be additionally performed to prevent shake of the microfluidic chip 200 arranged on the support unit 310.

Subsequently, the heat-sealing unit 320 of the sealing device is heated (step S820), and the heated heat-sealing unit 320 may be moved (step S830). That is, the heat contact unit 322 may contact and heat the inlet unit 210 and the outlet unit 230 of the microfluidic chip 200 by moving the heat-sealing unit 320 toward the microfluidic chip 200 after the heat contact unit 322 of the heat-sealing unit 320 is heated to a predetermined temperature (see FIG. 10). According to the contact-heating like this, at least a portion of the inlet unit 210 and the outlet unit 230 of the microfluidic chip 200 (particularly, at least a portion of the protrusion units 214 and 234) may be melted and move to the openings 212 and 232.

Subsequently, the microfluidic chip 200 may be sealed (step S840). Step S840 may be accomplished by sealing the inlet unit 210 and the outlet unit 230 as at least a portion of the inlet unit 210 and the outlet unit 230 of the microfluidic chip 200 (particularly, at least a portion of the protrusion units 214 and 234) is melted, moves to the openings 212 and 232 and is hardened. Here, although the hardening may be accomplished by separating the heat-sealing unit 320 contacting with the microfluidic chip 200 from the microfluidic chip 200 (see FIG. 11), according to embodiments, the hardening may be accomplished by blocking the heat applied to the microfluidic chip 200 as the heat contact unit 322 of the heat-sealing unit 320 is cooled down.

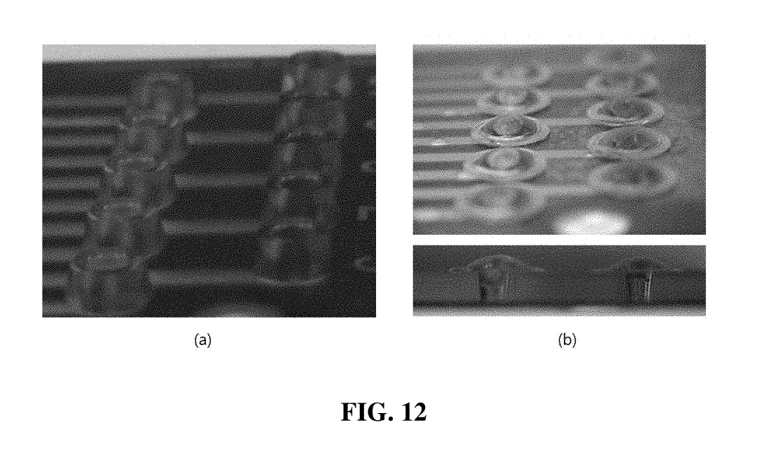

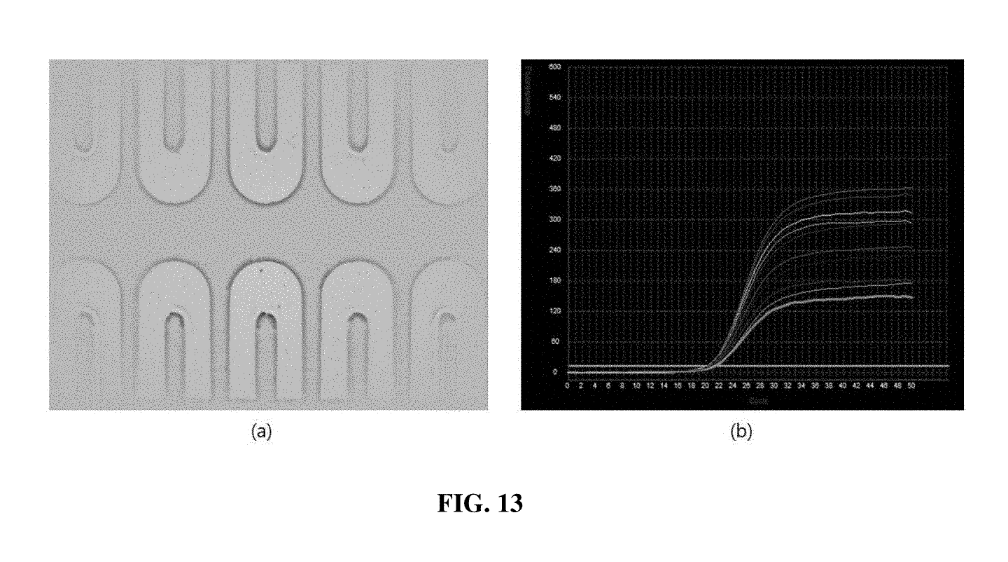

FIG. 12 shows an exemplary sealing result of a microfluidic chip according to an embodiment of the present invention.

Referring to FIG. 12(a), the inlet unit and the outlet unit of the microfluidic chip are shown. As shown in the figure, each of the inlet unit and the outlet unit may include an opening through which a fluid flows in and a protrusion unit which is defined to be protruded and located adjacent to the opening.

Referring to FIG. 12(b), a microfluidic chip sealed by the sealing device of the microfluidic chip is shown. As shown in the figure, as heat is applied to the protrusion units by the sealing device of the microfluidic chip, at least a portion of the protrusion units is melted, and the melted protrusion units move to the openings and are hardened to seal the openings.

FIG. 13 shows an exemplary reaction result of a sealed microfluidic chip according to an embodiment of the present invention.

As shown in FIG. 13(a), it can be confirmed that although a certain reaction (e.g., a PCR reaction) is performed on the microfluidic chip after sealing is accomplished on the microfluidic chip by the sealing device of the microfluidic chip, bubbles conventionally generated by evaporation of the fluid in the reaction region almost do not exist.

In addition, referring to FIG. 13(b), since the bubbles are not generated, distortion of reaction results can be prevented, and thus reaction results having further improved reliability can be acquired.

Although operations are shown in the figure in a specific order, it should not be construed that these operations should be performed in the specific order shown in the figure or in a sequential order or all the operations shown in the figure should be performed to accomplish a desired result.

Optimum embodiments have been disclosed in the figures and the specifications as described above. Although specific terms are used herein, these are used only to describe the present invention, not to restrict the meaning or to limit the scope of the present invention disclosed in the claims. Therefore, it may be understood that those skilled in the art may make various modifications and equivalent other embodiments from the embodiments. Accordingly, the true technical protection scope of the present invention should be determined by the technical spirits of the attached claims.

1-13. (canceled)

14. A microfluidic chip comprising:
an inlet through which a fluid flows in;
a reaction region connected to the inlet; and
an outlet connected to the reaction region, wherein each of the inlet and the outlet has an opening and a protrusion is defined adjacent to the opening.

15. The microfluidic chip of claim 14, wherein the protrusion has a configuration to be melt down and seal the opening when heat applies.

16. The microfluidic chip of claim 14, wherein the protrusion has a tapered shape in a cross-section view having a narrower radius as spaced away from the microfluidic chip.

17. The microfluidic chip of claim 14, wherein the protrusion is defined around the opening.

18. The microfluidic chip of claim 14, wherein the protrusion has smaller width as spaced away from the microfluidic chip.

19. The microfluidic chip of claim 14, wherein the opening has a tapered shape in a cross-section view having a greater radius as spaced away from the microfluidic chip.

20. A sealing device for a microfluidic chip, the sealing device comprising:
a support unit on which the microfluidic chip is arranged, wherein the microfluidic chip comprises an inlet, a reaction region, and an outlet; and
a heat-sealer sealing the inlet and the outlet of the microfluidic chip by applying heat.

21. The device according to claim 20, wherein each of the inlet and the outlet of the microfluidic chip comprises a protrusion, and wherein the heat-sealer melts down the protrusion by applying heat and seals the inlet and the outlet.

22. The device of claim 21, wherein the heat-sealer includes:
heat contactor thermally contacting with the inlet and the outlet of the microfluidic chip;
heaters heating the heat contactor; and
a temperature sensor measuring temperature of the heat contactor.

23. The device of claim 22, wherein a chip contact region of the heat contactor has a recessed shape corresponding to the protrusion of the inlet and the outlet, and the recessed shape guides the protrusion to seal the inlet and the outlet when the protrusion is melted down by the heat contactor.

24. The device of claim 23, wherein a release agent is coated on a surface of the chip contact region of the heat contactor.

25. The device of claim 23, wherein the recessed shape is in a hemisphere shape.

26. The device according to claim 20, further comprising a driving unit moving the heat-sealer toward the microfluidic chip arranged on the support unit to apply heat to the inlet and the outlet of the microfluidic chip through the heat-sealer.

27. The device according to claim 26, wherein the heat-sealer has a hole and has a chip fixing unit in the hole.

28. The device according to claim 27, wherein the chip fixing unit is elastically inserted in the hole; is protruded from the hole in a predetermined length; and contacts the microfluidic chip at least a portion.

29. The device according to claim 20, wherein the support unit is recessed to accommodate the microfluidic chip.

30. The microfluidic chip of claim 14, wherein the protrusion has a tapered shape in a cross-section view having a narrower radius as spaced away from the microfluidic chip.

31. The microfluidic chip of claim 14, wherein the protrusion is defined around the opening and has smaller width as spaced away from the microfluidic chip.

32. The microfluidic chip of claim 14, wherein the opening has a tapered shape in a cross-section view having a greater radius as spaced away from the microfluidic chip.

33. A sealing system of a microfluidic chip, the sealing system comprising:
the sealing device comprising:
a support unit on which the microfluidic chip is arranged,
wherein the microfluidic chip comprises an inlet through which a fluid flows in; a reaction region connected to the inlet; and an outlet connected to the reaction region, wherein each of the inlet and the outlet has an opening and a protrusion unit is defined adjacent to the opening; and
a heat-sealer melting the protrusion by applying heat and sealing the opening of the inlet and the outlet of the microfluidic chip.
